(19) United States
(12) Patent Application Publication
(10) Pub. No.: US 2016/0344612 A1
(43) Pub. Date: Nov. 24, 2016

(54) METHOD AND DEVICE FOR FORWARDING A PACKET

(71) Applicant: YANDEX EUROPE AG, Luzern (CH)

(72) Inventor: Denys Vladimirovich OVSIYENKO, Ugledar, Donetsk region (RU)

(21) Appl. No.: 15/110,804

(22) PCT Filed: Nov. 11, 2014
(86) PCT No.: PCT/IB14/65966

§ 371 Date: Jul. 11, 2016

(30) Foreign Application Priority Data
May 7, 2014 (RU) 2014118336

(51) Int. Cl. H04L 12/751; H04L 12/937; H04L 12/935; H04L 12/713

(52) U.S. Cl. CPC H04L 45/02; H04L 45/586; H04L 49/253; H04L 49/3027; H04L 49/3018; H04L 45/64

(57) ABSTRACT

Method of configuring a packet-forwarding network device comprising a plurality of network ports including a first input port, a first output port, a second input port, and a second output port, by a controller via a communications network, comprising: configuring a loopback device to couple first output port to second input port such that packets forwarded to first output port are received via second input port; programming of network device by controller with a first forwarding rule for causing packets received via first input port and having a first attribute to be forwarded to first output port; and programming of network device by controller with a second forwarding rule for causing packets received via second input port and having a second attribute to be forwarded to second output port. Also network device configured according to above method and method of using such devices.

### CROSS-REFERENCE

The present application claims priority to Russian Patent Application No. 2014118336, filed May 7, 2014, entitled “METHOD AND DEVICE FOR FORWARDING A PACKET” the entirety of which is incorporated herein.

### FIELD

The present technology relates to methods and devices for forwarding a packet, and specifically, using a loopback device.

### BACKGROUND

In packet-switched communication networks such as the Internet and the overwhelming majority of enterprise networks, end nodes communicate with one another by sending and receiving packets via one or more packet-forwarding network devices, such as switches and routers, which act as relays to move the packets across the various network segments of the communications network. Each packet-forwarding device is programmed with one or more forwarding rules used to determine whether and along what route to forward each packet received. By programming each packet-forwarding device in a network with suitable rules, a network architect may thus implement an overarching forwarding policy which governs the manner in which any packet received by the network is to be handled.

Until recently, configuration and management of packet-switched network required piecemeal configuration of its component network devices, which in turn required network architects to familiarize themselves with the particular idiosyncrasies of individual vendors' devices and their underlying communications technologies. This has changed with the introduction of software-defined networks (SDN) and the release of network devices compliant with the OpenFlow™ specification, developed by the Open Networking Foundation. The OpenFlow™ specification includes a communications protocol for remotely programming packet-forwarding network devices with forwarding rules. As a result, the forwarding policy of a communications network composed of disparate packet-forwarding network devices compliant with OpenFlow™ can now be centrally managed and controlled, without regard to which vendor(s) produced the network devices.

There have been several releases of the OpenFlow™ specification over the last few years. The first version intended to be suitable for implementation by vendors was OpenFlow™ version 1.0, which was released in December 2009. Since then, several newer versions of the specification have been released, the highest version number currently being OpenFlow™ version 1.4.0. Complete official documentation regarding the OpenFlow™ specification may be obtained from the website of the Open Networking Foundation.

Despite the fact that several newer versions of the specification have been released, many OpenFlow™ devices in use today comply only with version 1.0 of the specification, meaning they do not necessarily incorporate features that were added in later versions. In particular, because OpenFlow™ version 1.0 only specifies the existence of a single table of forwarding rules, OpenFlow™ version 1.0 packet-forwarding devices lack the ability to perform “pipeline processing” of packets via rules contained in multiple tables. As a result, in some circumstances, the range of forwarding policies which may be implemented using conventionally-configured OpenFlow™ version 1.0 packet-forwarding devices is limited.

### SUMMARY

Aspects of the present technology are directed to configuring packet-forwarding network devices using a loopback device to increase the range of forwarding policies which may be implemented using these devices. More specifically, by configuring the loopback device to couple a first port of the network device to a second port of the network device, packets may be forwarded to the first port according to a first rule and consequently received via the second port in order to enable the packet to be handled a second time according to a second rule. Because each pass of the packet through the network device presents an opportunity to selectively forward or drop the packet based on a respective forwarding rule, the looping back of the packet via the loopback device enables the matching criteria of multiple forwarding rules to be applied in respect of a packet, even when the network device includes only one table of forwarding rules, as is the case, for example, with an OpenFlow™ version 1.0 packet-forwarding network device. It should be noted, however, that while the present technology is well-suited for use with network devices which included only one table of forwarding rules, it is not limited to this context, and the techniques described herein may also be used with network devices that include more than one table of forwarding rules, such as those compliant with version of the OpenFlow™ specification equal to or greater than version 1.1.

Accordingly, in one aspect, various implementations of the present technology provide a remotely-configurable packet-forwarding network device comprising:
a memory;
a processor;
a plurality of network ports including a first input port, a first output port, a second input port, and a second output port, at least one of the network ports being in communication with a controller via a communications network;
a loopback device configured to couple the first output port to the second input port such that packets forwarded to the first output port are consequently received via the second input port; and
program instructions stored in the memory and executable by the processor to effect
   receiving from the controller via the communications network an indication of a first forwarding rule for causing packets received via the first input port and having a first attribute to be forwarded to the first output port,
   storing the first forwarding rule in the memory,
   receiving from the controller via the communications network an indication of a second forwarding rule for causing packets received via the second input port and having a second attribute to be forwarded to the second output port, and
   storing the second forwarding rule in the memory.

As those skilled in the art will understand, the memory may comprise various memory areas which could be implemented using various technologies, non-limiting examples of which includes random access memory, disk drives, solid state drives, and flash memory. In some implementations, the first forwarding rule and the second forwarding rule are stored in a same memory area as the program instructions, while in other implementations, one or more of the first forwarding rule, the second forwarding rule, and the program instructions may be stored in distinct memory areas.

In some implementations, storing the first forwarding rule in the memory comprises storing the first forwarding rule in a unique table of forwarding rules in the memory; and storing the second forwarding rule in the memory comprises storing the second forwarding rule in the unique table of forwarding rules.

In some implementations, the first output port and the second input port are physical ports, and the loopback device comprises at least one physical device configured to electronically couple the first output port to the second input port. In some such implementations, the at least one physical device consists of a network cable having a first end coupled to the first output port and a second end coupled to the second input port.

In some implementations, the first output port and the second input port are virtual ports, and the loopback device is a virtual loopback device configured to logically couple the first output port to the second input port.

In some implementations, the network device further comprises a second loopback device; the plurality of network ports further includes a third input port and a third output port; the second loopback device is configured to couple the second output port to the third input port such that packets forwarded to the second output port are consequently received via the third input port; and the program instructions are executable by the processor to further effect receiving from the controller via the communications network an indication of a third forwarding rule for causing packets received via the third input port and having a third attribute to be forwarded to the third output port, and storing the third forwarding rule in the memory.

In another aspect, various implementations of the present technology provide a method of configuring a packet-forwarding network device, the network device comprising a plurality of network ports including a first input port, a first output port, a second input port, and a second output port, at least one of the network ports being in communication with a controller via a communications network, the method comprising:
configuring a loopback device to couple the first output port to the second input port such that packets forwarded to the first output port are consequently received via the second input port;
causing programming of the network device, by the controller, via the communications network, with a first forwarding rule for causing packets received via the first input port and having a first attribute to be forwarded to the first output port; and
causing programming of the network device, by the controller, via the communications network, with a second forwarding rule for causing packets received via the second input port and having a second attribute to be forwarded to the second output port.

In some implementations, the network device further comprises a memory storing a unique table of forwarding rules; causing programming of the network device with the first forwarding rule comprises causing the network device to store the first forwarding rule in the unique table of forwarding rules; and causing programming of the network device with the second forwarding rule comprises causing the network device to store the second forwarding rule in the unique table of forwarding rules.

In some implementations, the first output port and the second input port are physical ports, the loopback device comprises at least one physical device, and configuring the loopback device comprises configuring the at least one physical device to electronically couple the first output port to the second input port. In some such implementations, the at least one physical device consists of a network cable, and configuring the at least one physical device comprises coupling a first end of the network cable to the first output port and coupling a second end of the network cable to the second input port.

In some implementations, the first output port and the second input port are virtual ports, the loopback device comprises a virtual loopback device, and configuring the loopback device comprises configuring the virtual loopback device to logically couple the first output port to the second input port.

In some implementations, the plurality of network ports further includes a third input port and a third output port, and the method further comprises:
configuring a second loopback device to couple the second output port to the third input port such that packets forwarded to the second output port are consequently received via the third input port; and
causing programming of the network device, by the controller, via the communications network, with a third forwarding rule for causing packets received via the third input port and having a third attribute to be forwarded to the third output port.

In another aspect, various implementations of the present technology provide a method of configuring a packet-forwarding network device, the network device comprising a plurality of network ports including a first input port, a first output port, a second input port, and a second output port, and a loopback device configured to couple the first output port to the second input port such that packets forwarded to the first output port are consequently received via the second input port, at least one of the network ports being in communication with a controller via a communications network, the method comprising:
programming the network device, by the controller, via the communications network, with a first forwarding rule for causing packets received via the first input port and having a first attribute to be forwarded to the first output port; and
programming the network device, by the controller, via the communications network, with a second forwarding rule for causing packets received via the second input port and having a second attribute to be forwarded to the second output port.

In some implementations, the network device further comprises a memory storing a unique table of forwarding rules; programming the network device with the first forwarding rule comprises causing the network device to store the first forwarding rule in the unique table of forwarding rules; and programming the network device with the second forwarding rule comprises causing the network device to store the second forwarding rule in the unique table of forwarding rules.

In some implementations, the first output port and the second input port are physical ports and the loopback device comprises at least one physical device configured to electronically couple the first output port to the second input port. In some such implementations, the at least one physical device consists of a network cable having a first end coupled to the first output port and a second end coupled to the second input port.

In some implementations, the first output port and the second input port are virtual ports and the loopback device is a virtual loopback device configured to logically couple the first output port to the second input port.

In some implementations, the plurality of network ports further includes a third input port and a third output port; the network device further comprises a second loopback device configured to couple the second output port to the third input port such that packets forwarded to the second output port are consequently received via the third input port; and further comprising programming the network device, by the controller, via the communications network, with a third forwarding rule for causing packets received via the third input port and having a third attribute to be forwarded to the third output port.

In another aspect, various implementations of the present technology provide a packet-forwarding network device configured for forwarding a packet, the network device comprising:
a memory storing a first forwarding rule and a second forwarding rule;
a processor;
a plurality of network ports including a first input port, a first output port, a second input port, and a second output port, at least one of the network ports being in communication with a controller via a communications network;
a loopback device configured to couple the first output port to the second input port such that packets forwarded to the first output port are consequently received via the second input port; and
program instructions stored in the memory and executable by the processor to effect:
   receiving of the packet via the first input port;
   matching of the packet to the first forwarding rule based on a first attribute of the packet;
   forwarding of the packet to the first output port based on the first forwarding rule;
   receiving of the packet via the second input port;
   matching of the packet to the second forwarding rule based on a second attribute of the packet; and
   forwarding of the packet to the second output port based on the second forwarding rule.

In some implementations, the first forwarding rule and the second forwarding rule are stored in a unique table of forwarding rules in the memory.

In some implementations, the program instructions are executable by the processor to further effect modifying the packet such that the packet has the second attribute before forwarding the packet to the first output port.

In some implementations, the first output port and the second input port are physical ports, and the loopback device comprises at least one physical device configured to electronically couple the first output port to the second input port. In some such implementations, the at least one physical device consists of a network cable having a first end coupled to the first output port and a second end coupled to the second input port.

In some implementations, the first output port and the second input port are virtual ports, and the loopback device is a virtual loopback device configured to logically couple the first output port to the second input port.

In some implementations, the network device further comprises a second loopback device; the plurality of network ports further includes a third input port and a third output port; the second loopback device is configured to couple the second output port to the third input port such that packets forwarded to the second output port are consequently received via the third input port; and the program instructions are executable by the processor to further effect receiving of the packet via the third input port, matching of the packet to the third forwarding rule based on a third attribute of the packet, and forwarding of the packet to the third output port based on the third forwarding rule.

In another aspect, various implementations of the present technology provide a method of forwarding a packet by a packet-forwarding network device, the network device being programmed with a first forwarding rule and a second forwarding rule and comprising a plurality of network ports including a first input port, a first output port, a second input port, and a second output port, and a loopback device configured to couple the first output port to the second input port such that packets forwarded to the first output port are consequently received via the second input port, the method comprising:
receiving the packet via the first input port;
matching the packet to the first forwarding rule based on a first attribute of the packet;
forwarding the packet to the first output port based on the first forwarding rule;
receiving the packet via the second input port;
matching the packet to the second forwarding rule based on a second attribute of the packet; and
forwarding the packet to the second output port based on the second forwarding rule.

In some implementations, the network device further comprises a memory storing a unique table of forwarding rules, each of the first forwarding rule and the second forwarding rule being stored in the unique table of forwarding rules.

In some implementations, the method further comprises modifying the packet such that the packet has the second attribute before forwarding the packet to the first output port.

In some implementations, the first output port and the second input port are physical ports and the loopback device comprises at least one physical device configured to electronically couple the first output port to the second input port. In some such implementations, the at least one physical device consists of a network cable having a first end coupled to the first output port and a second end coupled to the second input port.

In some implementations, the first output port and second input port are virtual ports and the loopback device is a virtual loopback device configured to logically couple the first output port to the second input port.

In some implementations, the network device is further programmed with a third forwarding rule; the plurality of network ports further includes a third input port and a third output port; the network device further comprises a second loopback device configured to couple the second output port to the third input port such that packets forwarded to the second output port are consequently received via the third input port; and further comprising receiving the packet via the third input port, matching the packet to the third forwarding rule based on a third attribute of the packet, and forwarding the packet to the third output port based on the third forwarding rule.

The “attribute” of a packet used to match the packet to a forwarding rule can refer to one or more properties of the packet. In the examples provided herein, the source IP address, destination IP address, destination TCP port, and/or the identity of the network port via which the packet was received are compared to a set of allowable values of those properties defined by the forwarding rules. But in various implementations of the present technology, the attribute used to match the packet to a forwarding rule could include one or more other properties, such as one or more of the “flow match fields” described in section 7.2.2.7 of the OpenFlow™ version 1.4.0 specification. Non-limiting examples include various metadata associated with the packet, a source or destination network hardware address (such as an Ethernet or MAC address), VLAN ID, IP protocol number, various port information (whether relating to TCP, UDP, or other ports), and MPLS label.

Thus, in some implementations of above aspects of the present technology, the first attribute includes a source internet protocol address being a member of a set of allowable source internet protocol addresses defined by the first forwarding rule. In some implementations of above aspects of the present technology, the first attribute includes a destination internet protocol address being a member of a set of allowable destination internet protocol addresses defined by the first forwarding rule. In some implementations of above aspects of the present technology, the first attribute includes a destination port number being a member of a set of allowable destination port numbers defined by the first forwarding rule. The second attribute (and third attribute, etc., as the case may be), may likewise take into account such types of matching criteria.

In the context of the present specification, the expression “information” includes information of any nature or kind whatsoever capable of being stored in a database. Thus information includes, but is not limited to, audiovisual works (images, movies, sound records, presentations etc.), data (location data, numerical data, etc.), text (opinions, comments, questions, messages, etc.), documents, spreadsheets, etc.

In the context of the present specification, an “indication of” an information element may be the information element itself or a pointer, reference, link, or other indirect mechanism enabling the recipient of the indication to locate a network, memory, database, or other computer-readable medium location from which the information element may be retrieved. For example, an indication of a file could include the file itself (i.e. its contents), or it could be a unique file descriptor identifying the file with respect to a particular filesystem, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “memory” is intended to include memory of any nature and kind whatsoever, including RAM, ROM, disks (CD-ROMs, DVDs, floppy disks, hard drives, etc.), USB keys, solid state-drives, tape drives, etc.

The functions of the various elements shown in the figures, including any functional block labeled as a “processor”, may be provided through the use of dedicated hardware and/or hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included. Software modules, or simply modules which are implied to be software, may be represented herein as any combination of flowchart elements or other elements indicating performance of process steps and/or textual description. Such modules may be executed by hardware that is expressly or implicitly shown. It should also be noted that, unless otherwise explicitly specified herein, the drawings are not to scale.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, a first device should be understood to be “in communication with” a second device if each of the devices is capable of sending information to and receiving information from the other device, across any physical medium or combinations of physical media, at any distance, and at any speed. As a non-limiting example, two digital electronic device(s) may communicate over a communications network such as the Internet. As another non-limiting example, the devices may run on the same digital electronic hardware, in which case communication may occur by any means available on such digital electronic hardware, such as inter-process communication.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a context diagram of a networked computing environment including a packet-forwarding network device configured according to an implementation of the present technology;

FIG. 2 is a table of forwarding rules of a packet-forwarding network device configured according to a conventional approach;

FIG. 3 is a table of forwarding rules of a packet-forwarding network device configured according to an implementation of the present technology;

FIGS. 4 and 5 are flowcharts illustrating methods of configuring network devices according to implementations of the present technology;

FIG. 6 is a flowchart illustrating a method of forwarding a packet by a network device according to an implementation of the present technology; and

FIG. 7 is a block diagram depicting a flow of a packet through a packet-forwarding network device illustrating various implementations of the present technology.

### DETAILED DESCRIPTION

It should be noted that all examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simple implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where example modifications to an element of the present technology are not provided, it should neither be interpreted that no modifications to the element are possible, nor that the provided description of the element represents the sole manner of implementing that element.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

We will now consider some non-limiting, illustrative examples to illustrate various implementations of aspects of the present technology.

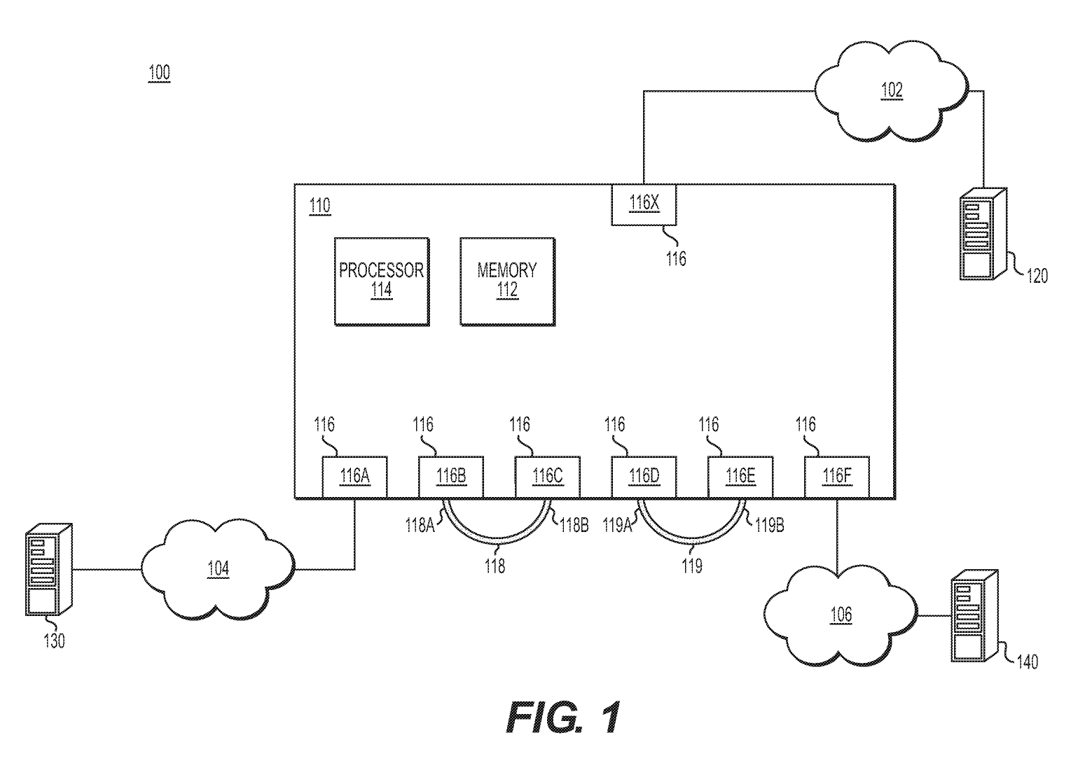

Referring to FIG. 1, there is shown a diagram depicting an exemplary networked computing environment 100 including a network device 110, a controller 120, a personal computer 130 and a web server 140. Network device 110 comprises a memory 112, a processor 114, and a plurality of network ports 116 including network ports 116A, 116B, 116C, 116D, 116E, 116F, and 116X. Each of the network ports 116 may be, for example, a Gigabit Ethernet port suitable to receive a twisted-pair Gigabit Ethernet cable.

As depicted in FIG. 1, network port 116X is in communication with controller 120 via a communications network 102, network port 116A is in communication with personal computer 130 via a communications network 104, and network port 116F is in communication with web server 140 via a communications network 106. Network port 116B is coupled to a first end 118A of a network cable 118 (such as a twisted-pair Gigabit Ethernet cable) and network port 116C is coupled to a second end 118B of the network cable 118, such that packets sent from one of network port 116B and 116C are received by the other. Likewise, network port 116D is coupled to a first end 119a of a network cable 119 (such as a twisted-pair Gigabit Ethernet cable) and network port 116E is coupled to a second end 119b of the network cable 119, such that packets sent from one of network port 116D and 116E are received by the other.

It will be appreciated that, while network device 110 as depicted in FIG. 1 is configured with two loopback devices (network cables 118 and 119), in other implementations of the present technology not depicted, the network device could be configured with just one loopback device or with more than two loopback devices.

Moreover, although network device 110 is depicted in FIG. 1 as being in communication with controller 120 via a dedicated network port 116X, in other implementations (not depicted), network device 110 could be in communication with controller 120 via one of the network ports of a forwarding plane (not separately numbered), that is, one of network ports 116A to 116F.

Network device 110 may be an internet protocol version 4 (IPv4) router which complies with the OpenFlow™ version 1.0 specification, and controller 120 may be a controller which also complies with the OpenFlow™ version 1.0 specification, such that controller 120 may be used to configure network device 110 using OpenFlow™ Protocol messages via communications network 102. These messages may include indications of forwarding rules to be stored in a table of forwarding rules in memory 112 of network device 110. In alternative implementations, the network device 110 may be a switch (such as a Gigabit Ethernet switch) which complies with the OpenFlow™ version 1.0 specification. In other implementations, the network device may be a packet-forwarding device which complies with a version of the OpenFlow™ specification other than version 1.0 and/or implements a networking standard other than IPv4 or Gigabit Ethernet. Personal computer 130 may be a standard desktop computer running Microsoft™ Windows 8™, and web server 140 may be a standard computer running a Linux™-based operating system and Apache web server software. Needless to say, the personal computer 130 and/or web server 140 may be configured in any other suitable manner.

Each one of communications networks 102, 104, and 106 may be a packet-switched network such as the Internet, a local area network, or another such communications network comprised of any number of network links and network devices suitable for relaying packets. Networking technologies which could be used to implement communications networks 102, 104, and 106 include but are not limited to dial-up, leased line, ISDN, optical, broadband, power-line, fiber-optics, DSL, Wi-Fi, cable, satellite, and cellular data, among others. Known internetworking protocols (i.e. TCP/IP) may be used in conjunction with such technologies along with higher level protocols (i.e. HTTP) to effect communications between devices coupled to these communications networks 102, 104, 106. Moreover, while each of communications network 102, communications network 104, and communications network 106 is depicted as a distinct communications network in FIG. 1, in other implementations (not depicted), two or more of these communications networks 102, 104, 106 may be a same communications network.

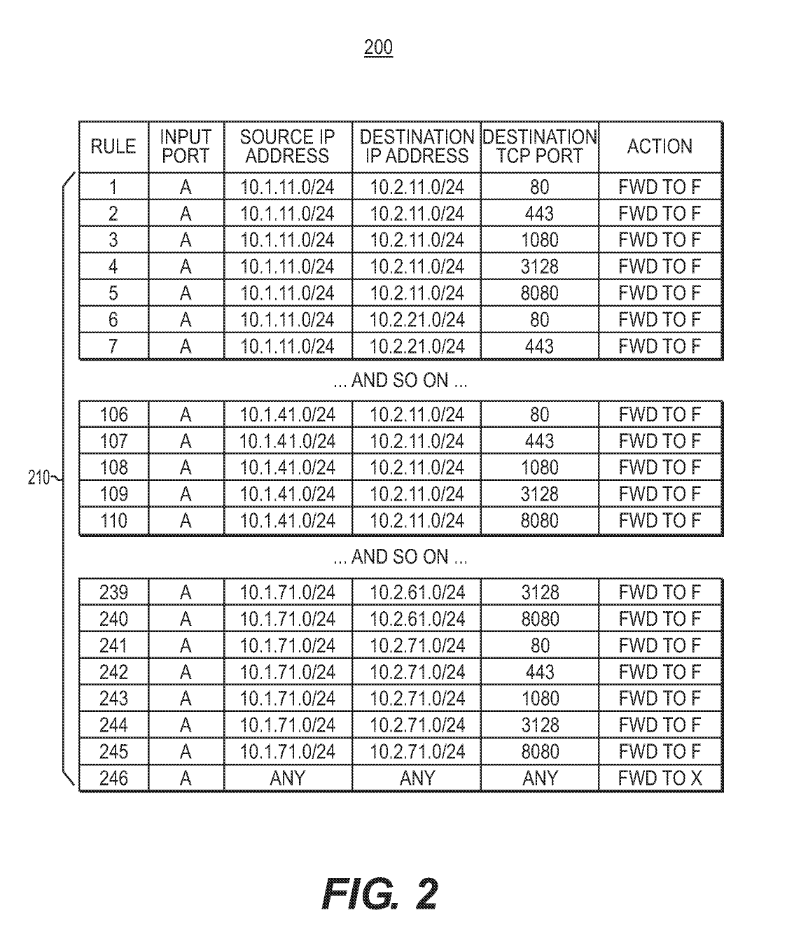

In FIG. 2, a table 200 of forwarding rules 210 corresponding to an exemplary forwarding policy is partially shown. In this example, the forwarding policy is as follows: forward to port F (e.g. corresponding to port 116F of network device 110 in FIG. 1) any packet which meets all of the following criteria:
(1) received at port A (e.g. corresponding to port 116A of network device 110); and
(2) has a source IP address within subnet 10.1.11.0/24 OR subnet 10.1.21.0/24 OR subnet 10.1.31.0/24 OR 10.1.41.0/24 OR 10.1.51.0/24 OR 10.1.61.0/24 OR 10.1.71.0/24; and
(3) has a destination IP address within subnet 10.2.11.0/24 OR 10.2.21.0/24 OR 10.2.31.0/24 OR 10.2.41.0/24 OR 10.2.51.0/24 OR 10.2.61.0/24 OR 10.2.71.0/24; and
(4) has a destination TCP port of 80 OR 443 OR 1080 OR 3128 OR 8080.

If any of these criteria is not satisfied, forward the packet to the controller (e.g. via port 116X).

In order to implement this policy without a loopback device, all of the combinations of the above criteria must be accounted for. Since factor (2) above contemplates seven allowable source IP subnets, factor (3) contemplates seven allowable destination IP subnets, and factor (4) contemplates five allowable destination TCP ports, the number of forwarding rules required is equal to the cross product of these orthogonal factors, or 7×7×5=245 forwarding rules, plus an additional rule to indicate what action to take in respect of packets which do not meet the criteria. For the sake of brevity, only rules 1 to 7, 106 to 110, and 239 to 246 are shown in FIG. 2.

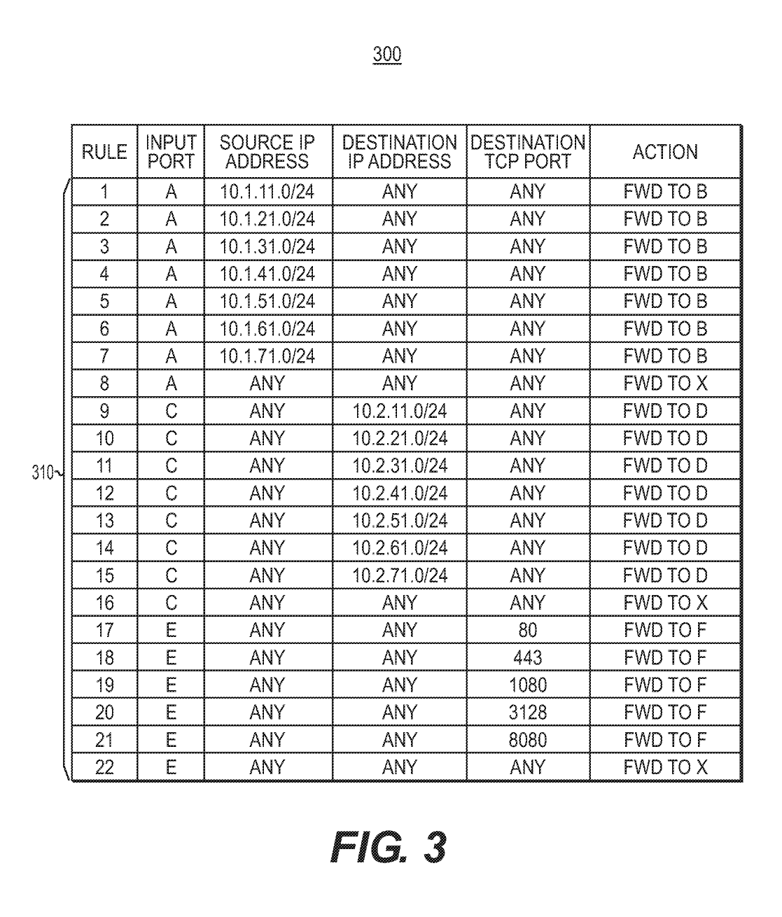

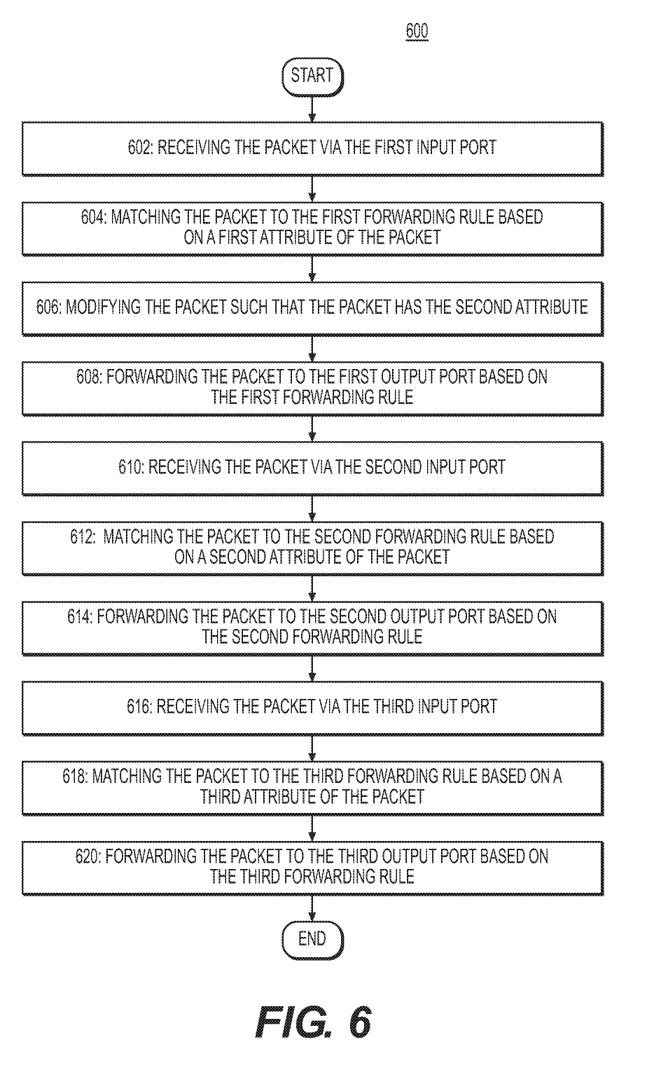

In FIG. 3, an alternative table 300 of forwarding rules 310 for implementing the same forwarding policy as that depicted in FIG. 2 is shown, but this time using two loopback devices (e.g. network cables 118 and 119 of FIG. 1). The technical effect attributable at least partially to the use of the two loopback devices is a significant reduction in the number of forwarding rules required, from 246 rules to just 22. This result is achieved because each of the loopback devices 118, 119 acts, in effect, like a logical disjunction (OR function) of all of the matching criteria which cause packets to be forwarded via that loopback device, thus eliminating the need to program individual forwarding rules in respect of each combination of values for each allowable source IP subnet, destination IP subnet, and destination TCP port. An example of the forwarding of a packet according to the forwarding rules 310 of table 300 will be described below with reference to FIG. 6.

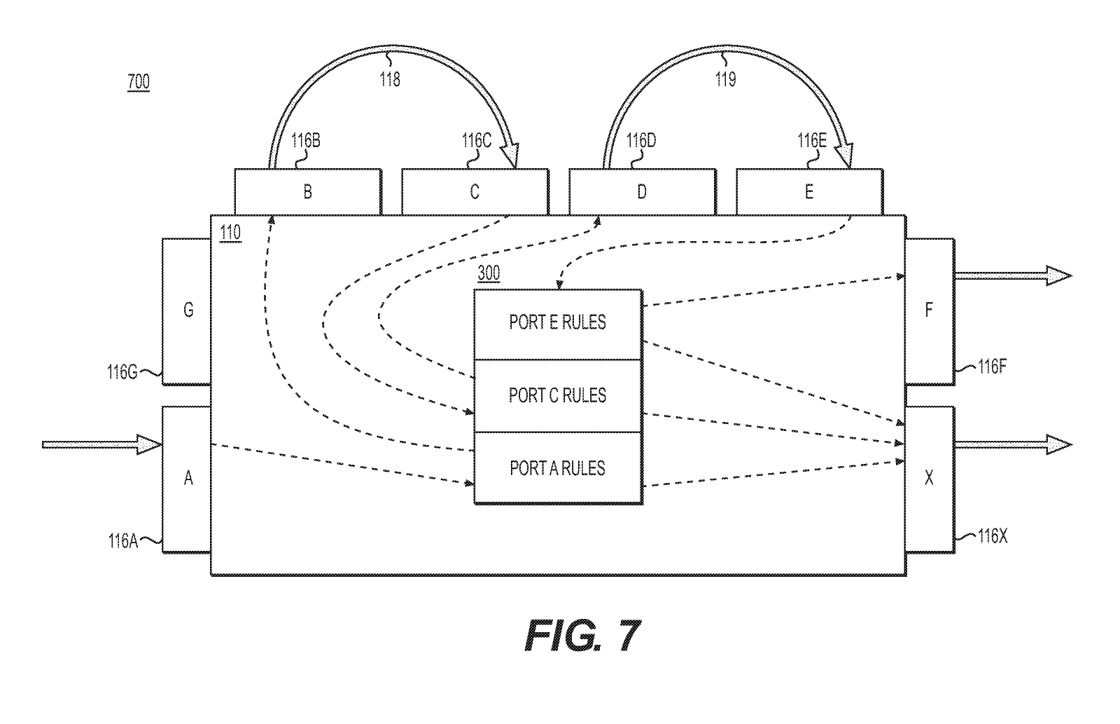

It will be appreciated that, according to the OpenFlow™ specifications, each packet may be matched to only one of the forwarding rules 210 in the table 200, therefore only the first forwarding rule whose matching criteria are satisfied by the packet will be applied to the packet. Thus, while the matching criteria of rule 8 in FIG. 3 would match a packet with any source IP address, any destination IP address, and any destination TCP port, rule 8 would only be applied to a packet which did not satisfy the matching criteria of any of the earlier rules 1 to 7 appearing in table 300. Rule 8 thus serves to “catch” any packet received on port A (port 116A in FIG. 7) which cannot be matched to any one of rules 1 to 7. Rules 16 and 22 serve an analogous function in respect of packets received via port C (port 116C in FIG. 7) and port E (port 116E in FIG. 7), respectively.

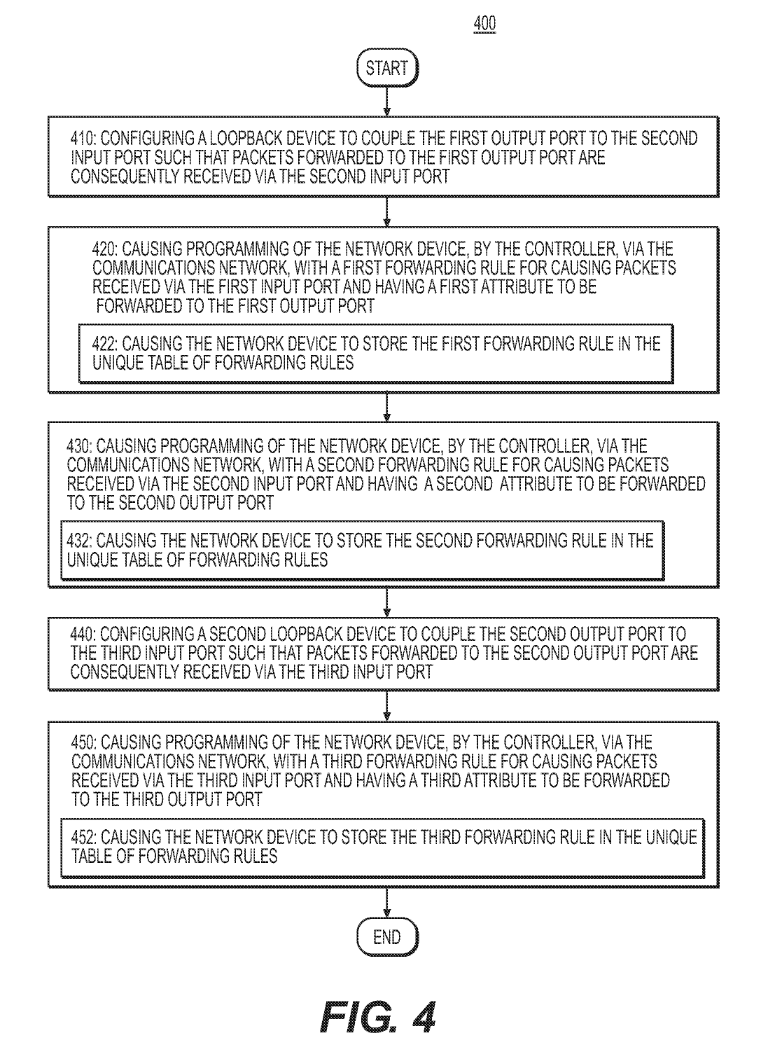

With reference now to FIG. 4, a flowchart corresponding to a method of configuring a packet-forwarding network device according to the present technology is shown. More specifically, FIG. 4 shows a method 400 of configuring a packet-forwarding network device such as the network device 110 shown in FIG. 1, the network device 110 comprising a memory 120 storing a unique table 300 of forwarding rules 310, a plurality of network ports including a first input port 116A, a first output port 116B, a second input port 116C, a second output port 116D, a third input port 116E, and a third output port 116F, at least one of the network ports (e.g. 116X) being in communication with a controller 120 via a communications network 102. Method 400 may be carried out, for example, by an operator of network device 110.

The method 400 comprises several steps. At step 410, a loopback device 118 is configured to couple the first output port 116B to the second input port 116C is configured such that packets forwarded to the first output port 116B are consequently received via the second input port 116C. For example, in some implementations, loopback device 118 may be a twisted pair Ethernet cable, and configuring the loopback device 118 may comprise coupling the respective ends of the cable to the first output port 116B and the second input port 116C. In other implementations, the first output port and second input port may be virtual ports and the loopback device may consist of a virtual loopback device, meaning that instead of a physical connection such as a network cable between physical ports, virtual ports may be created (i.e. implemented in software of the network device 110) and logically coupled via a virtual loopback device (i.e. also implemented in software of the network device 110).

At step 420, programming of the network device 110, by the controller 120, via the communications network 102, with a first forwarding rule for causing packets received via the first input port 116A and having a first attribute to be forwarded to the first output port 116B, is caused. Step 420 comprises step 422, wherein storing by the network device 110 of the first forwarding rule in the unique table 300 of forwarding rules 310 is caused.

Likewise, at step 430, programming of the network device 110 with a second forwarding rule for causing packets received via the second input port 116C and having a second attribute to be forwarded to the second output port 116D, is caused. Step 432 comprises step 432, wherein storing by the network device 110 of the second forwarding rule in the unique table 300 of forwarding rules 310 is caused. In implementations of the present technology comprising only one loopback device, the method 400 may be completed after step 432. In other implementations, a second loopback device may be configured at step 440 to couple the second output port 116D to the third input port 116E such that packets forwarded to the second output port are 116D consequently received via the third input port 116E, followed by causing programming at steps 450 (including storage in the unique table 300 of forwarding rules 310 at step 452) of a third forwarding rule in like manner to steps 420/422 in respect of the first forwarding rule and steps 430/432 in respect of the second forwarding rule.

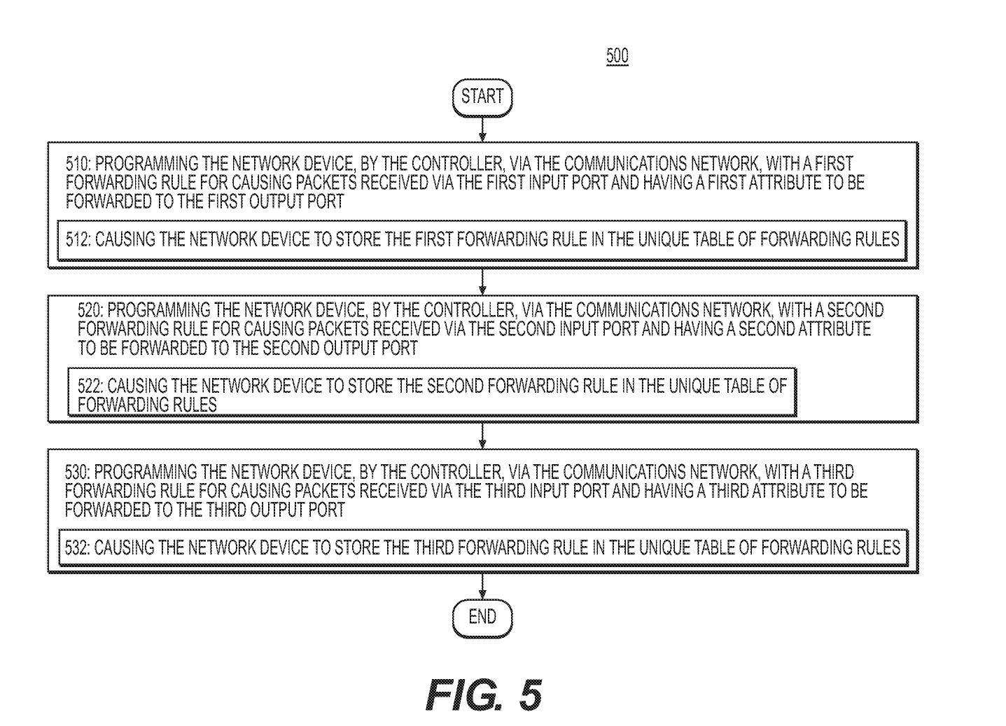

In FIG. 5, a flowchart corresponding to another non-limiting implementation of a method of configuring a packet-forwarding network device is shown. More specifically, FIG. 5 shows a method 500 of configuring a packet-forwarding network device such as the network device 110 of FIG. 1, the network device 110 comprising a memory 120 storing a unique table 300 of forwarding rules 310, a plurality of network ports including a first input port 116A, a first output port 116B, a second input port 116C, a second output port 116D, a third input port 116E, and a third output port 116F, as well as a loopback device 118 configured to couple the first output port 116B to the second input port 116C such that packets forwarded to the first output port 116B are consequently received via the second input port 116C, at least one of the network ports (e.g. 116X) being in communication with a controller 120 via a communications network 102. Method 500 may be carried out, for example, by an operator of the controller 120.

The method 500 comprises several steps. At step 510, the network device 110 is programmed by the controller 120 via the communications network 102 with a first forwarding rule for causing packets received via the first input port 116A and having a first attribute to be forwarded to the first output port 116B. Step 510 comprises step 512, wherein storing by the network device 110 of the first forwarding rule in the unique table 300 of forwarding rules 310 is caused. At steps 520/522, steps 510/512 are likewise performed in respect of a second forwarding rule for causing packets received via the second input port 116C and having a second attribute to be forwarded to the second output port 116D. In implementations of the present technology comprising only one loopback device 118, the method 500 may be completed after step 522. In implementations making use of a second loopback device 119, steps 530/532 are performed to program the network device with a third forwarding rule for causing packets received via the third input port 116E and having a third attribute to be forwarded to the third output port 116F, in like manner to the programming of the first and second forwarding rules at steps 510/512 and 520/522, respectively. It will be appreciated that in some implementations, the network device 110 is programmed with at least one of the first forwarding rule, the second forwarding rule, and the third forwarding rule by receiving an indication of that forwarding rule from the controller 120 via the communications network 102 and storing that forwarding rule in the memory 112.

With reference now to FIG. 6, a method of using a device configured according to above-described methods 400, 500 is shown. More specifically, FIG. 6 shows a method 600 of forwarding a packet by a packet-forwarding network device 110, the network device 110 having been programmed with a first forwarding rule, a second forwarding rule, and a third forwarding rule, and comprising a plurality of network ports including a first input port, a first output port, a second input port, a second output port, a third input port, and a third output port 116F, as well as a loopback device 118 configured to couple the first output port 116B to the second input port 116C such that packets forwarded to the first output port 116B are consequently received via the second input port 116C, and a second loopback device 119 configured to couple the second output port 116D to the third input port 116E such that packets forwarded to the second output port 116D are consequently received via the third input port 116E.

Method 600 comprises several steps. At step 602, a packet is received via the first input port 116A. For example, with reference to FIG. 1, the packet may be received via port 116A after having been sent by personal computer 130 via communications network 104, the packet having a source IP address of 10.1.61.113 (perhaps corresponding to an IP address of personal computer 130), a destination IP address of 10.2.21.82 (perhaps corresponding to an IP address of web server 140), and a destination TCP port of 443 (corresponding to an encrypted web connection).

At step 604, the packet is matched to a first forwarding rule based on a first attribute of the packet. For example, with reference to FIG. 3, the first attribute may be the source IP address of the packet, and the packet may be matched to rule 6 in table 300 because it was received by the network device 110 via port A (116A) and it has a source IP address of 10.1.61.113, which is within the 10.1.61.0/24 subnet specified by the matching criteria of rule 6.

Next, in some implementations, step 606 is performed, consisting of modifying the packet such that the packet has a second attribute. (For example, the second attribute could be a particular destination TCP port of the packet satisfying the matching criteria of a second forwarding rule, and modifying the packet to have that destination TCP port would thereby cause the second forwarding rule to be matched to the packet when the packet is later received at the second input port 116C at step 610, below.)

At step 608, the packet is forwarded to the first output port (e.g. port 116B of network device 110 in FIG. 1) based on the first forwarding rule (e.g. rule 6, which indicates that the “action” to be taken is to forward the packet to port B). Because the first output port 116B is coupled to the second input port 116C via a loopback device (such as network cable 118 of FIG. 1), the packet is consequently received via the second input port 116C at step 610, thus rendering it susceptible of being processed anew by network device 110.

At step 612, the packet is matched to a second forwarding rule based on a second attribute of the packet. For example, with reference to FIG. 3, the second attribute may be the destination IP address of the packet, and the packet may be matched to rule 10 because it was received via port C (116C) and it has a destination IP address of 10.2.21.82, which is within the 10.2.21.0/24 subnet specified by the matching criteria of rule 10.

At step 614, the packet is forwarded to the second output port 116D based on the second forwarding rule (e.g. rule 10). In implementations of the present technology comprising only one loopback device (not depicted), the second output port 116D may be an output port in communication with the destination node of the packet, for example the second output port could be port 116F in FIG. 1.

In other implementations, such as the two-loopback device implementation actually depicted in FIG. 1, the second output port could be port 116D, which is coupled to port 116E via the second loopback device 119. In such implementations, step 616, wherein the packet is received via the third input port (port 116E) would consequently ensue.

At step 618, the packet is matched to the third forwarding rule based on a third attribute of the packet. For example, with reference to FIG. 3, the third attribute may be the destination TCP port of the packet, and the packet may be matched to rule 18 because it was received via port E (116E) and it has a destination TCP port of 443, as specified by the matching criteria of rule 18.

At step 620, the packet is forwarded to the third output port 116F based on the third forwarding rule (e.g. rule 18). From there, the packet may be routed across any further network segments (e.g. those of communications network 106) toward its destination (e.g. web server 140).

FIG. 7 serves to illustrate the above-described exemplary flow of a packet through network device 110 via configured loopback devices 118 and 119 in accordance with the forwarding rules 310 of table 300. The potential flow paths of other packets according to forwarding rules 310 of table 300 other than rules 6, 10, and 18 are also depicted in FIG. 7, including flow paths wherein the packet is forwarded to port 116X.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A remotely-configurable packet-forwarding network device comprising:
a memory;
a processor;
a plurality of network ports including a first input port, a first output port, a second input port, a second output port, a third input port, and a third output port, at least one of the network ports being in communication with a controller via a communications network;
a first loopback device configured to couple the first output port to the second input port such that packets forwarded to the first output port are sequentially received via the second input port;
a second loopback device configured to couple the second output port to the third input port such that the packets forwarded to the second output port are sequentially received via the third input port, the second loopback device being sequentially configured to the first loopback device for forwarding the packets; and
program instructions stored in the memory and executable by the processor to effect:
receiving from the controller via the communications network an indication of a first forwarding rule for causing the packets received via the first input port and having a first attribute to be forwarded to the first output port and sequentially forwarded to the second input port;
storing the first forwarding rule in the memory;
receiving from the controller via the communications network an indication of a second forwarding rule for causing the packets received via the second input port and having a second attribute to be forwarded to the second output port and sequentially forwarded to the third input port; and
storing the second forwarding rule in the memory
receiving from the controller via the communications network an indication of a third forwarding rule for causing the packets received via the third input port and having a third attribute to be forwarded to the third output port, and
storing the third forwarding rule in the memory.

2. The network device of claim 1, wherein:
storing the first forwarding rule in the memory comprises storing the first forwarding rule in a unique table of forwarding rules in the memory; and
storing the second forwarding rule in the memory comprises storing the second forwarding rule in the unique table of forwarding rules.

3. The network device of claim 1, wherein the first output port and the second input port are physical ports, and the loopback device comprises at least one physical device configured to electronically couple the first output port to the second input port.

4. The network device of claim 3, wherein the at least one physical device consists of a network cable having a first end coupled to the first output port and a second end coupled to the second input port.

5. The network device of claim 1, wherein the first output port and second input port are virtual ports, and the loopback device is a virtual loopback device configured to logically couple the first output port to the second input port.

6.-7. (canceled)

8. The method of claim 7, wherein:
the network device further comprises a memory storing a unique table of forwarding rules;
causing programming of the network device with the first forwarding rule comprises causing the network device to store the first forwarding rule in the unique table of forwarding rules; and
causing programming of the network device with the second forwarding rule comprises causing the network device to store the second forwarding rule in the unique table of forwarding rules.

9. The method of claim 7, wherein the first output port and the second input port are physical ports, the loopback device comprises at least one physical device, and configuring the loopback device comprises configuring the at least one physical device to electronically couple the first output port to the second input port.

10. The method of claim 9, wherein the at least one physical device consists of a network cable, and configuring the at least one physical device comprises coupling a first end of the network cable to the first output port and coupling a second end of the network cable to the second input port.

11. The method of claim 7, wherein the first output port and the second input port are virtual ports, the loopback device comprises a virtual loopback device, and configuring the loopback device comprises configuring the virtual loopback device to logically couple the first output port to the second input port.

12. (canceled)

13. A method of configuring a packet-forwarding network device, the network device comprising a plurality of network ports including a first input port, a first output port, a second input port, a second output port, a third input port, and a third output port, a first loopback device configured to couple the first output port to the second input port such that packets forwarded to the first output port are sequentially received via the second input port, and a second loopback device configured to couple the second output port to the third input port such that the packets forwarded to the second output port are sequentially received via the third input port, the second loopback device being sequentially configured to the first loopback device for forwarding the packets, at least one of the network ports being in communication with a controller via a communications network, the method comprising:
programming the network device, by the controller, via the communications network, with a first forwarding rule for causing the packets received via the first input port and having a first attribute to be forwarded to the first output port and sequentially forwarded to the second input port;
programming the network device, by the controller, via the communications network, with a second forwarding rule for causing the packets received via the second input port and having a second attribute to be forwarded to the second output port and sequentially forwarded to the third input port; and
programming the network device, by the controller, via the communications network, with a third forwarding rule for causing the packets received via the third input port and having a third attribute to be forwarded to the third output port.

14. The method of claim 13, wherein:
the network device further comprises a memory storing a unique table of forwarding rules;
programming the network device with the first forwarding rule comprises causing the network device to store the first forwarding rule in the unique table of forwarding rules; and
programming the network device with the second forwarding rule comprises causing the network device to store the second forwarding rule in the unique table of forwarding rules.

15. The method of claim 13, wherein the first output port and the second input port are physical ports and the loopback device comprises at least one physical device configured to electronically couple the first output port to the second input port.

16. The method of claim 15, wherein the at least one physical device consists of a network cable having a first end coupled to the first output port and a second end coupled to the second input port.

17. The method of claim 13, wherein the first output port and second input port are virtual ports and the loopback device is a virtual loopback device configured to logically couple the first output port to the second input port.

18.-19. (canceled)

20. The network device of claim 19, wherein the first forwarding rule and the second forwarding rule are stored in a unique table of forwarding rules in the memory.

21. The network device of claim 19, wherein the program instructions are executable by the processor to further effect modifying the packet such that the packet has the second attribute before forwarding the packet to the first output port.

22. The network device of claim 19, wherein the first output port and the second input port are physical ports, and the loopback device comprises at least one physical device configured to electronically couple the first output port to the second input port.

23. The network device of claim 22, wherein the at least one physical device consists of a network cable having a first end coupled to the first output port and a second end coupled to the second input port.

24. The network device of claim 19, wherein the first output port and second input port are virtual ports, and the loopback device is a virtual loopback device configured to logically couple the first output port to the second input port.

25.-38. (canceled)

39. The method of claim 1, further comprising:
receiving of the packet via the first input port;
matching of the packet to the first forwarding rule based on a first attribute of the packet;
forwarding of the packet to the first output port based on the first forwarding rule;
receiving of the packet via the second input port;
matching of the packet to the second forwarding rule based on a second attribute of the packet;
forwarding of the packet to the second output port based on the second forwarding rule;
receiving of the packet via the third input port;
matching of the packet to the third forwarding rule based on a third attribute of the packet; and
forwarding of the packet to the third output port based on the third forwarding rule.

40. The method of claim 13, further comprising:
receiving the packet via the first input port;
matching the packet to the first forwarding rule based on a first attribute of the packet;
forwarding the packet to the first output port based on the first forwarding rule;
receiving the packet via the second input port;
matching the packet to the second forwarding rule based on a second attribute of the packet;
forwarding the packet to the second output port based on the second forwarding rule receiving the packet via the third input port;
matching the packet to the third forwarding rule based on a third attribute of the packet; and
forwarding the packet to the third output port based on the third forwarding rule.
